(19) United States
(12) Patent Application Publication
(10) Pub. No.: US 2014/0145870 A1
(43) Pub. Date: May 29, 2014

(54) Continuous Wave Electronic Disrupter

(71) Applicant: Kevin A. Boulais, LaPlata, MD (US)

(72) Inventor: Kevin A. Boulais, LaPlata, MD (US)

(73) Assignee: United States Government, as represented by the Secretary of the Navy, Arlington, VA (US)

(21) Appl. No.: 13/685,647

(22) Filed: Nov. 26, 2012

(51) Int. Cl. G01S 7/38

(52) U.S. Cl. CPC G01S 7/38
USPC 342/14

(57) ABSTRACT

A continuous wave electromagnetic apparatus is provided for emitting electronic interference against a target. The apparatus includes a several magnetrons that connect in series. The magnetrons are tuned to frequencies distinguishable from each other. Each magnetron generates a corresponding continuous wave signal at a corresponding wavelength. A multiplexer connects to the several magnetrons to concatenate each the signal into a combination signal. An emitter device connects to the multiplexer to discharge the combination signal towards the target.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

This invention relates to an electromagnetic technique to disrupt electronics. Such interference can be applicable to disable an electronic device or a computing device, for example, by using continuous wave electromagnetic emission.

### SUMMARY

Conventional electronic disrupters yield disadvantages addressed by various exemplary embodiments of the present invention. In particular, various exemplary embodiments provide a continuous wave electromagnetic apparatus for emitting electronic interference against a target. The apparatus includes several magnetrons that connect in series. The magnetrons are tuned to frequencies distinguishable from each other.

In exemplary embodiments, each magnetron generates a corresponding continuous wave signal at a corresponding wavelength. A multiplexer connects to several magnetrons to concatenate each signal into a combination signal. A radiating element connects to the multiplexer to discharge the combination signal towards the target.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a first graphical view of a superimposed electromagnetic pulse signal;

FIG. 2 is a second graphical view of superimposed electromagnetic signals;

FIG. 3 is an elevation view of a vehicle equipped with an exemplary disrupter; and

FIG. 4 is a tabular view of an exemplary comparative list of electromagnetic source performance characteristics.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

Various exemplary embodiments provide devices to disrupt electronics using continuous wave electromagnetic emission. Preferred embodiments include quantified parameters to maximize efficiency for mobile use. High efficiency reduces size, weight and reduces complexity for ruggedness and reliability. Both high average power and high peak power electromagnetic radiation are generated simultaneously utilizing simple continuous wave source. Consequently, these embodiments exemplify utility for the disruption of undiscovered hostile electronic devices.

The Federal Communications Commission (FCC) defines electromagnetic interference as “. . . any unwanted radio frequency signal that prevents you from watching television, listening to your radio/stereo or talking on your cordless telephone. Interference may prevent reception altogether, may cause only a temporary loss of a signal, or may affect the quality of the sound or picture produced by your equipment.” See http://www.fcc.gov/guides/interference-defining-source for further information. The FCC has rules and regulations that limit consumer electronics from transmitting in radio frequency (RF) bands that possess sufficiently high energy to disturb other electronic devices in one's home or a neighbor's home. In a worst case, such RF transmission could disrupt emergency communication leading to safety hazards or even fatality. High power radio frequency can, depending on total energy imparted, permanently damage sensitive electronic circuits.

The military has recognized electromagnetic interference from a defensive point of view, in which electronics must be hardened to prevent interference from disrupting operations, and from an offensive point of view in which the military could use high power microwaves (HPM) or rf-weapons to disrupt the electronics of an adversary. See http://www.fcc.gov/guides/interference-defining-source as well as W. M. Arkin, “‘Sci-Fi’ Weapons Going to War,” Los Angeles Times, Dec. 8, 2002; E. Epstein, “U.S. Has New Weapon Ready,” San Francisco Chronicle, Feb. 14, 2003; D. A. Fulghum, “Microwave Weapons May Be Ready for Iraq,” Aviation Week & Space Technology, 157 (6), Aug. 5, 2002; M. Kirkpatrick, “Weapons with a Moral Dimension,” Wall Street Journal, Jan. 14, 2003. These electromagnetic weapons generally come in two flavors:

(1) high power electromagnetic pulses, and

(2) high average power.

Each type can target specific needs, and each could be used to either temporarily disrupt or permanently damage electronic systems.

High average power devices can disable via thermal effects. For example, electronics can be disrupted or destroyed by overheating due to the absorption of a large amount of electromagnetic energy to burn out or disrupt an electric current component of a circuit. They can also be used for other applications such as the mobile Active Denial System (ADS) in which a beam of non-ionizing radiation is directed at humans to give the sensation of burning pain, but without injury. See http://en.wikipedia.org/wiki/Active_denial_system for further information. ADS is thought to be useful for crowd control.

High peak power devices carry relatively low energy, but can delivery that energy in a short period of time. These devices can disrupt or destroy electronics due to the high electric field, which for example, might breakdown semiconductor devices. A further advantage of the high peak power systems is that they represent a near delta function in time so the Fourier spectrum is wide-band in frequency. Thus, if there is frequency dependence in the target electronics, the wideband will most likely cover it. An extreme example of the disruptive effects of high peak power was in 1962 as part of Operation Fishbowl. Starfish was a particular test in that operation in which a nuclear device was detonated at an altitude of 400 kilometers (km). The generated electromagnetic pulse knocked out about three-hundred streetlamps, set of burglar alarms and damaged a telephone network in Hawaii.

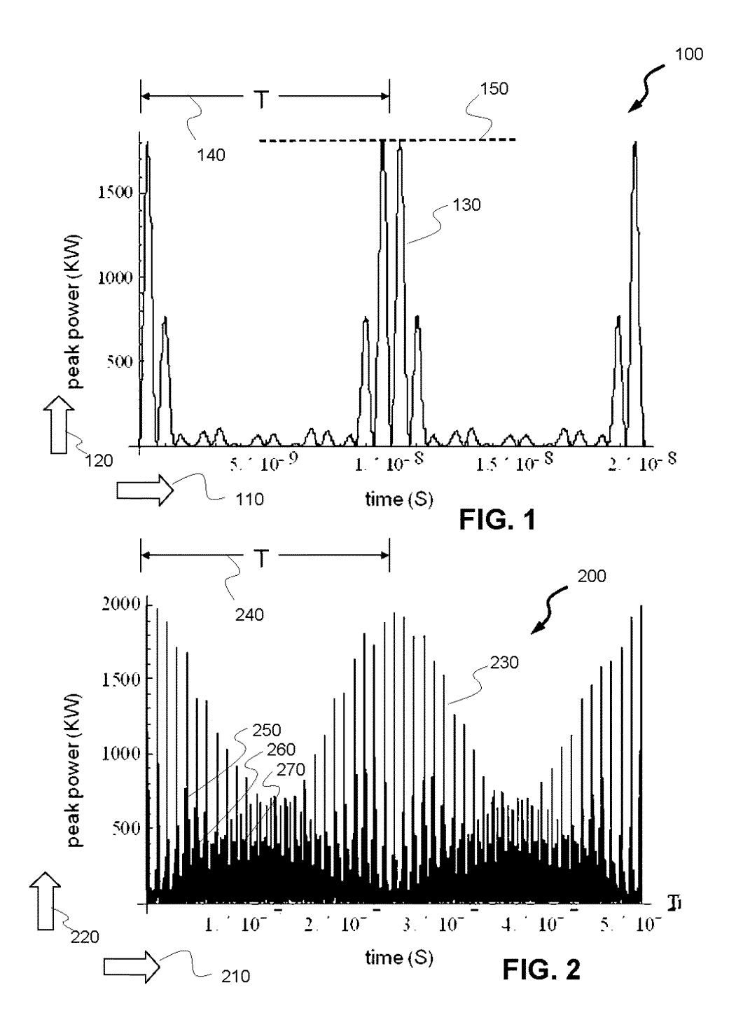

To disrupt or destroy unknown electronics, one can use both high average power devices and high peak power devices simultaneously. This can be accomplished using continuous wave (CW) devices radiating simultaneously such that the field amplitudes combine to form large peak powers. FIG. 1 shows a graphical view 100 of a power distribution waveform. The abscissa 110 represents time in seconds (s), and the ordinate 120 denotes peak power in kilowatts (kW). A signal 130 includes functions resembling sine-squared curves of temporally varying peaks at regular intervals. The period 140 of pattern repetition is denoted by T. The highest peak power level 150 is about 1800 kW.

For this example in view 100, the sum of five CW sources, each 40 kW in average power constructively interfering in free space. The five frequencies in this example are equally spaced in 100 MHz steps with the first frequency at 500 MHz and extending to 900 MHz. The peak power level 150 reaches 1800 kW from five concatenated 40 kW sources. Concurrently, a high average power is maintained at 40 kW×5=200 kW. Another advantage of this technique is the use of many frequencies, providing a higher probability of coupling into an electronic device. Of course, once in the electronics, the mixing can be quite different depending on the reception of the device to the various frequencies. Thus, for unknown electronics, particular selection of chosen frequencies is not particularly necessary beyond a general knowledge of common equipment.

An added advantage of this technique is that drifting frequencies are not important. This necessitates from lack of identification of the electronics being attacked. But even if the electronics were known, there is typically a large amount of outside unknowns. For example, the angle of incidence the radiation has on the electronics is most likely unknown due to the unknown orientation of the electronics, and the surrounding environment might not be known causing specular reflections, unknown absorption and other effects.

FIG. 2 shows a graphical view 200 as an example of a summed waveform in which the 600 MHz frequency has drifted to 604 MHz. The abscissa 210 represents time, and the ordinate 220 denotes peak power in comparable units as view 100. A signal 230 includes staggering spikes at a period 240 and reaching levels of about 2000 kW (or 2 MW). Shorter spikes 250, 260 and 270 exhibit complementary periodicity. This scatter view illustrates even more peaks are generated with a maximum peak power reaching 2000 kW. Thus, once they mix within the electronics, the same type of effect occurs, and in fact can be even more convoluted due to the heterodyne effects of semiconductor junctions and other non-linear devices that are typically present in electronic circuits.

There exist many other advantages to various exemplary embodiments as derived for optimal effects from a mobile platform. In turn, overall efficiency from a system engineering point of view was of prime concern. Efficient electromagnetic generation means reductions in prime power and cooling requirements. This in turn reduces system size and weight which are important for mobile platforms. Reduction in cooling reduces the prime power needed, and reduction in the required prime power necessitates diminished cooling requirements. Thus, all these considerations have a multiplying effect towards a compact efficient mobile system.

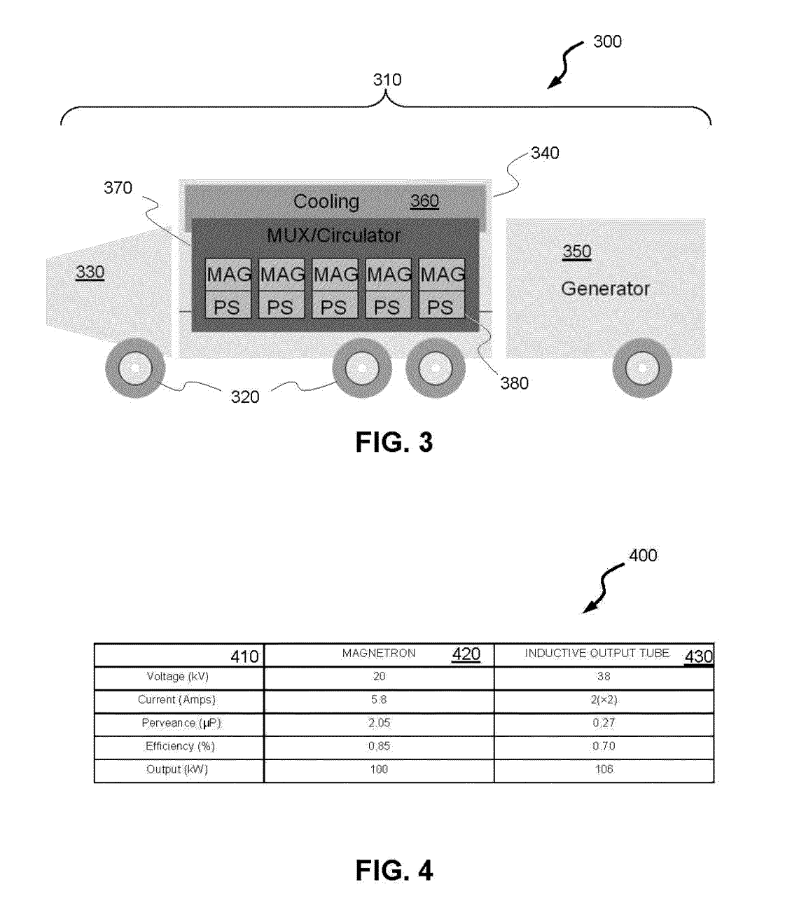

FIG. 3 shows an elevation view 300 for a depiction of the concept. The simplicity of the scheme is evident and important to enhance ruggedness and reliability. A semi-trailer truck 310 equipped with wheels 320 for road mobility includes a tractor cab 330, a fore cargo trailer 340 and aft cargo trailer 350 housing an electric generator. The fore cargo trailer 340 provides a cooling unit 360 for temperature conditioning a multiplexer 360 that houses five magnetron source units 370. Each of the five units 370 is housed in the covered rear of the truck 310 and has its own power supply. Alternatively, all the units 370 can be powered by a common power supply.

The RF output power is fed into a frequency band filter to prevent the magnetron output at one frequency from entering a magnetron at another frequency. At least one circulator can be used to protect the magnetron units 370 from electromagnetic radiation reflecting back therein. The circulator represents a three-port device with RF-in, RF-out and RF-return terminals to shunt feedback energy and thereby avoid contaminating the output signal from feedback. Following the filters, the combined electromagnetic power is radiated out through an emitter that represents an electromagnetic radiating element. Such an emitter can include an appropriate antenna for transmitting an electromagnetic wave. The generator is conceptually shown on the aft trailer 350, but could alternatively be disposed in the fore trailer 340.

FIG. 4 shows a tabular listing 400 of the advantages of using an oscillator tube instead of an amplifier. The left column 410 denotes a physical or performance characteristic. The middle column 420 identifies magnetron performance. The right column 430 indicates inductive output tube performance at comparable power output. Comparisons between the magnetron and inductive options reveal lower voltages (20 kV vs. 38 kV), higher currents (˜6 A vs. 4 A), higher efficiencies (85% vs. 70%), and comparable powers (100 kW vs. 106 kW). The reason for the voltage and power difference is that the perveance between these differ by an order of magnitude (˜2 pP vs. ˜0.3 μP).

The comparison is evidenced between a magnetron oscillator from Burle (RCA) model S94608E100, and an inductive output tube amplifier (IOT) from Communications and Power Industries model CHK2800W. Even though both systems have the same output power, the advantages of the magnetron oscillator are clear. The high-perveance cathode of the magnetron means operation at a lower voltage, thereby yielding less voltage stress, and reduced standoff distances. Perveance represents a characteristic of electron beam cathodes indicating space charge effect on a beam's motion. Further, the efficiency is considerably higher and the energy loss (not going into the electromagnetic wave) is half that of the IOTs. Thus, cooling needs are cut by half, further reducing system size and weight. Also, the prime power is reduced, and a smaller generator can be used.

Comparing the specifications in the tabular listing 400 between a magnetron oscillator and an inductive output tube amplifier favors the magnetron for a mobile compact efficient electronic disruption system. Both high peak power and high average power are derived simultaneously for maximum effectiveness. Frequency selection is not critical outside of a general knowledge of the electronics of interest. Although RF-tubes are assumed in this design, solid state devices can also be used with equipment that satisfies the power and frequency requirements.

Continuous wave oscillators eliminate the need for input sources and amplifiers, which would be needed if high power RF amplifiers were used instead. This reduces size, weight and complexity, which in turn renders the system more robust and reliable. Continuous wave devices eliminate the need for high voltage modulators, which reduces size, weight, increases overall efficiency, and greatly reduces system complexity. The elimination of high-voltage fast modulated pulses reduces problematic ground loops in the system design, which increases stability and reliability.

Because high voltage modulation is not required, high power RF oscillators can be used instead of high power RF amplifiers. Oscillators tend to be more efficient devices (such as the magnetrons found in kitchen microwave ovens) because they have higher Q-factors. Magnetrons typically use permanent magnets to reduce system complexity (increasing reliability) and obviate the necessity for electro-magnets and their power supplies. This also increases overall efficiency.

Magnetrons typically have higher perveance cathodes than other microwave tubes. This means that they run at lower voltages and higher currents. A rule of thumb in high voltage design is that packaging volume goes as voltage cubed due to the necessary stand-off distances in three dimensions. This also reduces weight for mobility, and increases reliability because there is less high voltage stress.

To generate a specifically tailored waveform can be produced using the Fourier components calculated to conform to the desired pattern. Artisans of ordinary skill will recognize that microwave tube oscillators other than magnetrons can be employed and remain within the scope of the invention.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A continuous wave electromagnetic apparatus for emitting electronic interference against a target, said apparatus comprising:
an electrical power supply that provides electromagnetic energy;
a plurality of oscillators that connect in series, said oscillators being tuned to frequencies distinguishable from each other, each oscillator of said plurality connecting to said power supply and thereby generating a corresponding continuous wave signal at a corresponding wavelength;
a multiplexer that connects to the plurality of oscillators to concatenate each said signal into a combination signal towards the target; and
an emitter that connects to said multiplexer to discharge said combination signal.

2. The apparatus according to claim 1, wherein each said oscillator is a magnetron.

3. The apparatus according to claim 1, wherein each said oscillator is a microwave tube oscillator.

4. The apparatus according to claim 1, wherein said emitter is a radiating element that includes an antenna for transmitting an electromagnetic wave.

5. The apparatus according to claim 1, wherein each said electrical power supply comprises a plurality of power supplies corresponding to said plurality of oscillators.

6. The apparatus according to claim 1, wherein said power supply is commonly connected to said plurality of oscillators.

7. The apparatus according to claim 1, wherein said continuous wave signals interfere with each other such that said combination signal includes temporal variation in peak power.

8. The apparatus according to claim 1, wherein said combination signal has a peak power output of approximately 100 kilowatts.

9. The apparatus according to claim 1, wherein said power supply includes a frequency band filter.

10. The apparatus according to claim 2, wherein each said magnetron includes a circulator.

11. The apparatus according to claim 1, wherein said signal includes pulses separated by equal frequency spacing therebetween.

12. The apparatus according to claim 1, wherein said signal includes pulses having non-uniform frequency spacing therebetween.
